(19) United States
(12) Patent Application Publication
(10) Pub. No.: US 2020/0313442 A1
(43) Pub. Date: Oct. 1, 2020

(54) MULTI-POWER MANAGEMENT SYSTEM AND MULTI-POWER MANAGEMENT METHOD

(71) Applicants: Wei-Chih Shih, Taipei City (TW); Liang-Jui Chien, Taipei City (TW); Yi-Hsun Lin, Taipei City (TW)

(72) Inventors: Wei-Chih Shih, Taipei City (TW); Liang-Jui Chien, Taipei City (TW); Yi-Hsun Lin, Taipei City (TW)

(73) Assignee: COMPAL ELECTRONICS, INC., Taipei City (TW)

(21) Appl. No.: 16/736,828

(22) Filed: Jan. 8, 2020

Related U.S. Application Data
(60) Provisional application No. 62/790,436, filed on Jan. 9, 2019.

(51) Int. Cl. H02J 7/00; H02J 7/02

(52) U.S. Cl. CPC H02J 7/007; H02J 2207/20; H02J 7/02

(57) ABSTRACT

A multi-power management system and a multi-power management method are provided. The multi-power management system includes a plurality of adapters and an electronic device. The adapters are configured to receive an external alternating current power source and provide a plurality of power supplies. The electronic device communicates with the adapters to acquire power values of the power supplies. When the electronic device enters a power-off state, according to a required power value of the electronic device in the power-off state and the power values of the power supplies, at least one of the adapters is selected to provide the power supplies, and unselected adapters are stopped receiving the external alternating current power source.

### CROSS-REFERENCE TO RELATED APPLICATION

This application claims the priority benefit of U.S. provisional application Ser. No. 62/790,436, filed on Jan. 9, 2019. The entirety of the above-mentioned patent application is hereby incorporated by reference herein and made a part of this specification.

### TECHNICAL FIELD

The disclosure relates to a power management system and a power management method, and in particular, to a multi-power management system and a multi-power management method that can reduce power consumption.

### DESCRIPTION OF RELATED ART

In recent years, applications connected to a plurality of external power sources begin to be imported into an electronic device (for example, a notebook computer), and according to the related art, the main function is to only provide sufficient power to operate the system of the electronic device smoothly.

However, according to power consumption standards, evaluation is mainly performed according to use states of the electronic device and a plurality of adapters. Therefore, a multi-power input electronic device still needs to conform to the current power consumption specifications. When the electronic device is used with the adapters due to the requirement for functional design, the total power consumption of the electronic device and the adapters in a power-off state may exceed the requirement under the current energy regulations. Therefore, when the electronic device connected to a plurality of external power sources is powered off, the power consumption needs to be further reduced to meet the current energy regulations.

### SUMMARY

The disclosure provides a multi-power management system and a multi-power management method capable of reducing power consumption in a power-off state.

The multi-power management system provided in the disclosure includes a plurality of adapters and an electronic device. The adapters are configured to receive an external alternating current power source and provide a plurality of power supplies. The electronic device includes a selection module and a controller. The selection module is coupled to the adapters. The controller is coupled to the selection module. The controller is configured to communicate with the adapters via the selection module to acquire power values of the power supplies provided by the adapters. When the electronic device enters a power-off state, the controller is further configured to instruct, according to a required power value of the electronic device in the power-off state and the power values of the power supplies, the selection module to select at least one of the adapters to provide at least one of the power supplies, and stop unselected adapters from receiving the external alternating current power source according to a control signal transmitted by the selection module.

The multi-power management method provided in the disclosure is adapted to a multi-power management system. The multi-power management system includes a plurality of adapters and an electronic device. The adapters receive an external alternating current power source according to a plurality of control signals and provide a plurality of power supplies. The multi-power management method includes: acquiring power values of the power supplies provided by the adapters; when the electronic device enters a power-off state, instructing, according to a required power value of the electronic device in the power-off state and the power values of the power supplies, a selection module to select at least one of the adapters to provide at least one of the power supplies, and stopping unselected adapters from receiving the external alternating current power source according to a control signal transmitted by the selection module.

Based on the above, in the power-off state, in the multi-power management system and the multi-power management method provided in the disclosure, the unselected adapters are controlled to stop receiving the external alternating current power source. As such, when the unselected adapters do not receive the external alternating current power source, there is no power consumption. Therefore, the power consumption of the multi-power management system in the power-off state may be reduced according to the disclosure.

To make the features and advantages provided in the disclosure clear and easy to understand, the following gives a detailed description of embodiments with reference to accompanying drawings.

### BRIEF DESCRIPTION OF THE DRAWINGS

FIG. 1 is a schematic diagram of a multi-power management system according to an embodiment of the disclosure.

FIG. 2 is a flowchart of a multi-power management method according to an embodiment of the disclosure.

FIG. 3 is a schematic diagram of a multi-power management system according to another embodiment of the disclosure.

FIG. 4 is a flowchart of a multi-power management method according to another embodiment of the disclosure.

### DESCRIPTION OF THE EMBODIMENTS

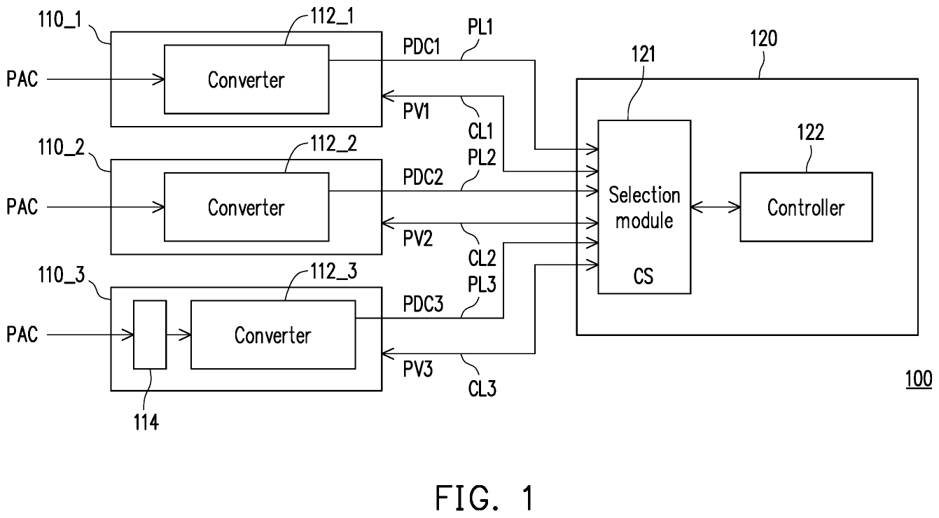

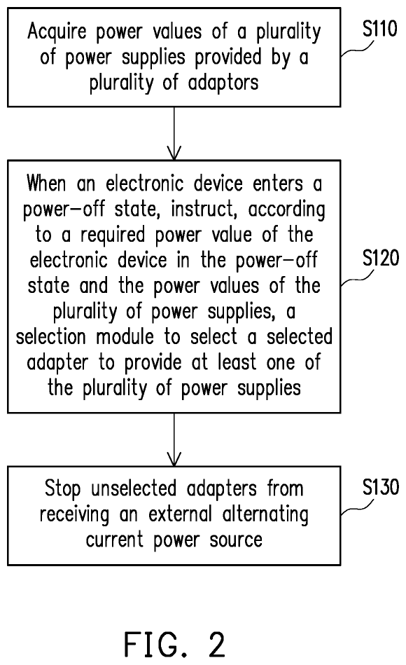

FIG. 1 is a schematic diagram of a multi-power management system according to an embodiment of the disclosure. FIG. 2 is a flowchart of a multi-power management method according to an embodiment of the disclosure. In the present embodiment, the multi-power management system 100 includes adapters 110_1, 110_2, and 110_3 and an electronic device 120. The adapters 110_1, 110_2, and 110_3 receive an external alternating current power source PAC and provide power supplies PDC1, PDC2, and PDC3. For example, the adapter 110_1 receives an external alternating current power source PAC and provides a power supply PDC1 via a power path PL1. The adapter 110_2 receives an external alternating current power source PAC and provides a power supply PDC2 via a power path PL2. The adapter 110_3 receives an external alternating current power source PAC and provides a power supply PDC3 via a power path PL3. In the present embodiment, the adapters 110_1, 110_2, and 110_3 receive the same external alternating current power source PAC. In some embodiments, the adapters 110_1, 110_2, and 110_3 receive external alternating current power sources that are not totally the same. In the present embodiment, the power supplies PDC1, PDC2, and PDC3 are direct current power sources. The power supplies PDC1, PDC2, and PDC3 may be the same or different from each other. For ease of description, the quantity of the adapters 110_1, 110_2, and 110_3 in the present embodiment is 3 for example. There may be a plurality of adapters in the disclosure, which is not limited to the present embodiment.

Further, for example, in the present embodiment, the adapter 110_1 includes a converter 112_1, and the converter 112_1 converts the external alternating current power source PAC into the power supply PDC1. The adapter 110_2 includes a converter 112_2, and the converter 112_2 converts the external alternating current power source PAC into the power supply PDC2. The adapter 110_3 includes a converter 112_3 and a power switch 114, and the power switch 114 is coupled to the converter 112_3. The converter 112_3 receives the external alternating current power source PAC via the power switch 114, and converts the external alternating current power source PAC into the power supply PDC3. The power switch 114 may be implemented by at least one transistor switch or transmission gate of any form.

The electronic device 120 may be a device such as a smartphone, a tablet computer, or a notebook computer. In the present embodiment, the electronic device 120 includes a selection module 121 and a controller 122. The selection module 121 is coupled to the adapters 110_1, 110_2, and 110_3. The controller 122 is coupled to the selection module 121. The controller 122 is, for example a central processing unit (CPU), or another programmable general-purpose or special-purpose microprocessor, a digital signal processor (DSP), a programmable controller, an application specific integrated circuit (ASIC), a programmable logic device (PLD), or another similar device or a combination of these devices, and may be loaded and execute a computer program. In the present embodiment, in step S110, the controller 122 communicates with the adapters 110_1, 110_2, and 110_3 via the selection module 121 to acquire a power value PV1 of the power supply PDC1 provided by the adapter 110_1, a power value PV2 of the power supply PDC2 provided by the adapter 110_2, and a power value PV3 of the power supply PDC3 provided by the adapter 110_3. In an operating state, when the electronic device 120 is electrically connected to the adapters 110_1, 110_2, and 110_3, the controller 122 acquires the power value PV1 of the power supply PDC1 via the selection module 121 and a communication path CL1. The controller 122 acquires the power value PV2 of the power supply PDC2 via the selection module 121 and a communication path CL2. The controller 122 acquires the power value PV3 of the power supply PDC3 via the selection module 121 and a communication path CL3.

In step S120, when the electronic device 120 enters a power-off state, the controller 122 instructs, according to a required power value of the electronic device 120 in the power-off state and the power values PV1, PV2, and PV3, the selection module 121 to select at least one of the adapters 110_1, 110_2, and 110_3 to provide at least one of the power supplies PDC1, PDC2, and PDC3.

In step S130, the electronic device 120 instructs the selection module 121 to transmit a control signal CS to adapters except the selected adapter, so that the unselected adapters stop receiving the external alternating current power source PAC according to the control signal CS. In the present embodiment, the control signal CS is transmitted via the communication paths (the communication paths CL1, CL2, and CL3).

For example, in step S110, the controller 122 acquires s that the power value PV1 of the power supply PDC1 provided by the adapter 110_1 is 15 watts, the power value PV2 of the power supply PDC2 provided by the adapter 110_2 is 60 watts, and the power value PV3 of the power supply PDC3 provided by the adapter 110_3 is 65 watts. Therefore, in the operating state, the electronic device 120 can obtain operating electricity of about 140 watts. When the electronic device 120 enters the power-off state, the controller 122 may acquire that the required power value of the electronic device 120 in the power-off state is 0.2 watts in step S120. The controller 122 determines that the power supply PDC1 provided by the adapter 110_1 is sufficient to supply a power requirement when the electronic device 120 enters the power-off state. Therefore, the controller 122 instructs the selection module 121 to select the adapter 110_1 as the selected adapter. In step S130, the selection module 121 transmits the control signal CS to the adapters 110_2 and 110_3 via the communication paths CL2 and CL3. The converter 112_2 of the adapter 110_2 is disabled according to the control signal CS, and the converter 112_2 cannot receive the external alternating current power source PAC. In addition, the power switch 114 of the adapter 110_3 is switched off according to the control signal CS, and therefore, the converter 112_3 cannot receive the external alternating current power source PAC. In this way, in step S130, the adapters 110_2 and 110_3 stop operating. Therefore, in the power-off state, the selection module 121 and the controller 122 may operate by using the power supply PDC1.

For another example, if the controller 122 may acquire that the required power value of the electronic device 120 in the power-off state is 45 watts in step S120, and the controller 122 determines that the power supply PDC2 provided by the adapter 110_2 is sufficient to supply a power requirement when the electronic device 120 enters the power-off state, the controller 122 instructs the selection module 121 to select the adapter 110_2 as the selected adapter. In step S130, the selection module 121 transmits the control signal CS to the adapters 110_1 and 110_3 via the communication paths CL1 and CL3. In this way, in step S130, the adapters 110_1 and 110_3 stop operating. Therefore, in the power-off state, the selection module 121 and the controller 122 may operate by using the power supply PDC2.

It is worth mentioning herein that the multi-power management system 100 controls the unselected adapters 110_2 and 110_3 to stop receiving the external alternating current power source PAC. In this way, when the adapters 110_2 and 110_3 do not receive the external alternating current power source PAC, there is no power consumption. Therefore, the power consumption of the multi-power management system 100 in the power-off state can be further reduced.

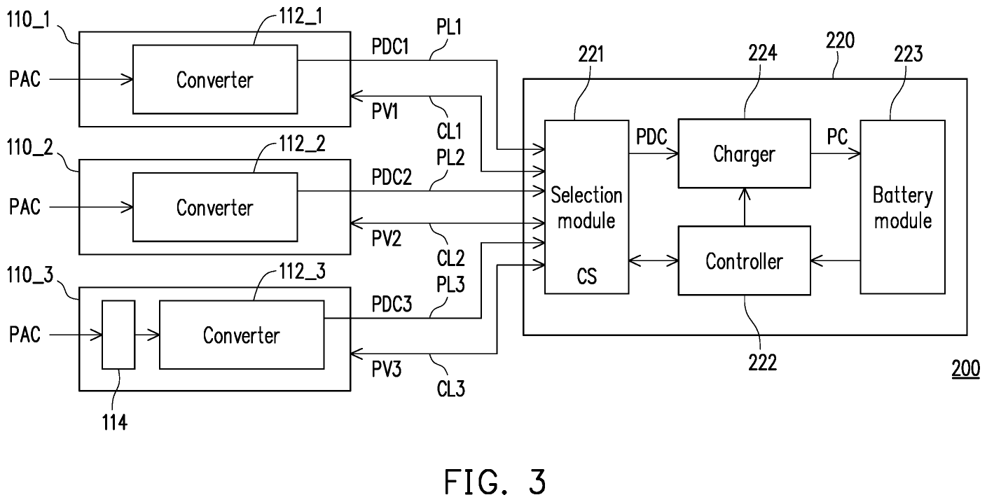

FIG. 3 is a schematic diagram of a multi-power management system according to another embodiment of the disclosure. In the present embodiment, the multi-power management system 200 includes adapters 110_1, 110_2, and 110_3 and an electronic device 220. Unlike the multi-power management system 100 (as shown in FIG. 1), in addition to a selection module 221 and a controller 222, the electronic device 220 further includes a battery module 223 and a charger 224. The remaining operating implementation details of the adapters 110_1, 110_2, and 110_3 may be sufficiently obtained from FIG. 1 and FIG. 2, and therefore are not described herein again.

In the present embodiment, the charger 224 is coupled to the selection module 221, the controller 222, and the battery module 223, the charger 224 receives a direct current power source PDC via the selection module 221, and the direct current power source PDC is associated with at least one of power supplies PDC1, PDC2, and PDC3. In the present embodiment, the direct current power source PDC is, for example, a total power source of the power supplies PDC1, PDC2, and PDC3, that is, a power value of the direct current power source PDC is roughly equal to a sum of power values PV1, PV2, and PV3 of the power supplies PDC1, PDC2, and PDC3. In some embodiments, the direct current power source PDC is, for example, a part of the total power source, that is, the power value of the direct current power source PDC is less than the sum of the power values PV1, PV2, and PV3 of the power supplies PDC1, PDC2, and PDC3. In some embodiments, the direct current power source PDC is, for example, one of the power supplies PDC1, PDC2, and PDC3. In addition, the charger 224 further converts the direct current power source PDC into a charging power source PC in response to control of the controller 222, and provides the charging power source PC to the battery module 223, to charge the battery module 223. Therefore, in the present embodiment, a required power value of the electronic device 220 includes a power value required for charging the battery module 223.

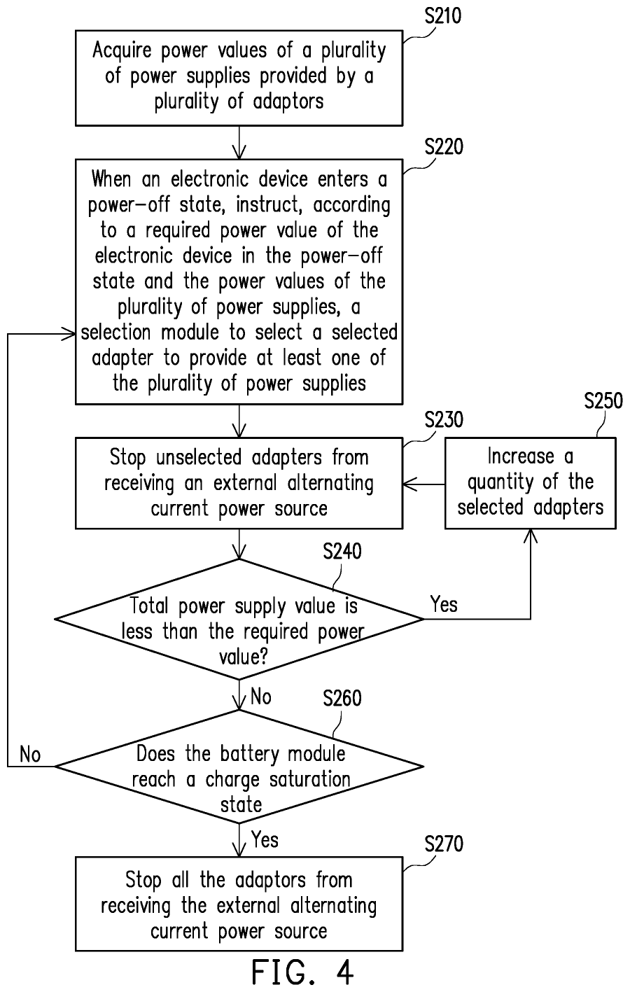

Please refer to FIG. 3 and FIG. 4 together. FIG. 4 is a flowchart of a multi-power management method according to another embodiment of the disclosure. In the present embodiment, in step S210, the controller 222 communicates with the adapters 110_1, 110_2, and 110_3 via the selection module 121 to acquire the power value PV1 of the power supply PDC1 provided by the adapter 110_1, the power value PV2 of the power supply PDC2 provided by the adapter 110_2, and the power value PV3 of the power supply PDC3 provided by the adapter 110_3. In step S220, when the electronic device 220 enters a power-off state, the controller 222 instructs, according to a required power value of the electronic device 220 in the power-off state and the power values PV1, PV2, and PV3, the selection module 221 to select at least one of the adapters 110_1, 110_2, and 110_3, to provide at least one of power supplies PDC1, PDC2, and PDC3. In step S230, the electronic device 220 instructs the selection module 221 to transmit a control signal CS, so that unselected adapters stop receiving the external alternating current power source PAC according to the control signal CS.

In step S240, the controller 222 determines whether a total power supply value of at least one power supply provided by the selected adapter is less than the required power value of the electronic device 220 in the power-off state. If the controller 222 determines that the total power supply value is less than the required power value, it means that the total power supply value currently provided by the selected adapter is insufficient. Therefore, when it is determined that the total power supply value is less than the required power value, the controller 222 instructs the selection module 221 to increase a quantity of the selected adapters in step S250, to increase the total power supply value, until all the adapters 112_1, 112_2, and 112_3 are used as the selected adapters, and then goes back to step S230. In some embodiments, in step S250, the controller 222 instructs the selection module 221 to replace at least one of the current at least one selected adapter with an adapter that can provide a larger power supply, to increase the total power supply value.

On the other hand, if the controller 222 determines that the total power supply value is greater than or equal to the required power value, it means that the total power supply value currently provided by the selected adapter is sufficient. Therefore, the multi-power management system 200 may charge the electronic device 220 in the power-off state by using the power supply provided by the selected adapter.

Next, in step S260, the controller 222 determines whether the battery module 223 reaches a charge saturation state. When the battery module 223 reaches the charge saturation state, the controller 222 instructs the selection module 221 to transmit the control signal CS in step S270, so that the adapters 110_1, 110_2, and 110_3 stop receiving the external alternating current power source PAC. On the other hand, when the battery module 223 has not reached the charge saturation state, the controller 222 goes back to step S220. In some embodiments, when the battery module 223 has not reached the charge saturation state, the controller 222 goes back to step S260.

For example, in step S210, the controller 222 acquires that the power value PV1 of the power supply PDC1 provided by the adapter 110_1 is 15 watts, the power value PV2 of the power supply PDC2 provided by the adapter 110_2 is 60 watts, and the power value PV3 of the power supply PDC3 provided by the adapter 110_3 is 65 watts. Therefore, in an operating state, the electronic device 220 can obtain operating electricity of 140 watts. When the electronic device 220 enters the power-off state (step S220), the controller 222 may acquire that the required power value of the electronic device 220 in the power-off state is 0.2 watts. The controller 222 can determine that the power supply PDC1 provided by the adapter 110_1 is sufficient to supply a power requirement when the electronic device 220 enters the power-off state. Therefore, the controller 222 instructs the selection module 221 to select the adapter 110_1 as the selected adapter. In step S230, the selection module 221 transmits the control signal CS to the adapters 110_2 and 110_3. Therefore, in step S230, the adapters 110_2 and 110_3 stop operating. In the power-off state, the selection module 221 and the controller 222 may operate by using the power supply PDC1, that is, the multi-power management system 200 may charge the electronic device 220 in the power-off state by using the power supply PDC1.

However, in the power-off state, if electricity stored in the battery module 223 decreases or a battery module 223 that has not reached the charge saturation state is assembled to the electronic device 220, the controller 222 acquires, according to the current electricity stored in the battery module 223, the power value required for charging the battery module 223. In this case, the required power value includes the power value required for charging the battery module 223. In step S240, the controller 222 acquires that the required power value rises to 70 watts, and determines that the current total power supply value (15 watts) is insufficient. Therefore, the controller 222 instructs the selection module 221 to select the adapters 110_1 and 110_2 as the selected adapters in step S250, and goes back to step S230 to instruct the selection module 221 to transmit the control signal CS to disable the adapter 110_3. Therefore, the controller 222 may determine that the total power supply value (75 watts) is greater than the required power value (70 watts) in step S240, and perform the next step S260. In addition, the controller 222 further enables the charger 224, and therefore, the multi-power management system 200 charges the battery module 223 by using the power supplies PDC1 and PDC2.

When determining that the battery module 223 reaches the charge saturation state in step S260, the controller 222 instructs the selection module 221 to transmit the control signal CS to the adapters 110_1, 110_2, and 110_3 in step S270, so that the adapters 110_1, 110_2, and 110_3 cannot receive the external alternating current power source PAC. In this way, in step S270, the adapters 110_1, 110_2, and 110_3 stop operating. In addition, the controller 222 further disables the charger 224. Therefore, when all the adapters 110_1, 110_2, and 110_3 are disabled, the selection module 221 and the controller 222 may operate by using the electricity of the battery module 223.

To sum up, in the power-off state, in the multi-power management system and the multi-power management method provided in the disclosure, the unselected adapters are controlled to stop receiving the external alternating current power source. As such, when the unselected adapters do not receive the external alternating current power source, there is no power consumption. Therefore, the power consumption of the multi-power management system in the power-off state may be effectively reduced according to the disclosure.

Although the disclosure is provided with reference to the above embodiments, the embodiments are not intended to be construed as limitations in the disclosure. A person of ordinary skill in the art may make variations and modifications without departing from the spirit and scope provided in the disclosure. Therefore, the protection scope provided in the disclosure should be subject to the appended claims.

What is claimed is:

1. A multi-power management system, comprising:
a plurality of adapters, configured to receive an external alternating current power source and provide a plurality of power supplies; and
an electronic device, comprising:
a selection module, coupled to the adapters; and
a controller, coupled to the selection module and configured to communicate with the adapters via the selection module to acquire power values of the power supplies provided by the adapters, and when the electronic device enters a power-off state, instruct, according to a required power value of the electronic device in the power-off state and the power values of the power supplies, the selection module to select at least one of the adapters to provide at least one of the power supplies, and stop unselected adapters of the adaptors from receiving the external alternating current power source according to a control signal transmitted by the selection module.

2. The multi-power management system according to claim 1, wherein each of the adapters comprises:
a converter, configured to receive the external alternating current power source, and convert the external alternating current power source into one of the power supplies.

3. The multi-power management system according to claim 2, wherein the converter is disabled according to the control signal, so that the converter stops receiving the external alternating current power source.

4. The multi-power management system according to claim 2, wherein
a first adapter of the adapters comprises a power switch,
the power switch is coupled to the converter of the first adapter,
the first adapter receives the external alternating current power source via the power switch, and converts the external alternating current power source by using the converter of the first adapter to provide a first power supply of the power supplies, and
the power switch is switched off according to the control signal, so that the first adapter stops receiving the external alternating current power source.

5. The multi-power management system according to claim 1, wherein
the controller is further configured to determine whether a total power supply value of the at least one power supply provided by the at least one selected adapter is less than the required power value,
when the total power supply value is less than the required power value, the controller instructs the selection module to increase a quantity of the at least one selected adapter, and
when the total power supply value is greater than the required power value, the controller stops, according to the power value of the at least one power supply provided by the at least one selected adapter, one of the at least one selected adapter from receiving the external alternating current power source.

6. The multi-power management system according to claim 1, wherein the electronic device further comprises:
a battery module; and
a charger, coupled to the selection module, the controller, and the battery module, and configured to receive a direct current power source via the selection module, convert the direct current power source into a charging power source in response to control of the controller, and provide the charging power source to the battery module, wherein
the direct current power source is associated with at least one of the power supplies, wherein the required power value comprises a power value required for charging the battery module.

7. The multi-power management system according to claim 6, wherein
the controller is further configured to determine whether the battery module reaches a charge saturation state, and
when the battery module reaches the charge saturation state, the controller instructs the selection module to stop the adapters from receiving the external alternating current power source.

8. A multi-power management method, adapted to a multi-power management system, wherein the multi-power management system comprises a plurality of adapters and an electronic device, the adapters receive an external alternating current power source according to a plurality of control signals and provide a plurality of power supplies, and the multi-power management method comprises:
acquiring power values of the power supplies provided by the adapters;
when the electronic device enters a power-off state, instructing, according to a required power value of the electronic device in the power-off state and the power values of the power supplies, a selection module to select at least one of the adapters to provide at least one of the power supplies; and
stopping unselected adapters from receiving the external alternating current power source according to a control signal transmitted by the selection module.

9. The multi-power management method according to claim 8, wherein each of the adapters comprises a converter, and the multi-power management method further comprises:
converting the external alternating current power source into one of the power supplies by using the converter.

10. The multi-power management method according to claim 9, wherein each of the adapters comprises a converter, and the step of stopping the unselected adapters from receiving the external alternating current power source according to the control signal provided by the selection module comprises:
disabling the converter according to the control signal to stop the converter from receiving the external alternating current power source.

11. The multi-power management method according to claim 9, wherein a first adapter of the adapters comprises a power switch, the first adapter receives the external alternating current power source via the power switch and converts the external alternating current power source to provide a first power supply of the power supplies, and the step of stopping the unselected adapters from receiving the external alternating current power source according to the control signal provided by the selection module comprises:
switching off the power switch according to the control signal, so that the first adapter stops receiving the external alternating current power source.

12. The multi-power management method according to claim 8, further comprising:
determining whether a total power supply value of the at least one power supply provided by the at least one selected adapter is less than the required power value;
when the total power supply value is less than the required power value, increasing a quantity of the at least one selected adapter;
when the total power supply value is greater than the required power value, stopping, according to the power value of the at least one power supply provided by the at least one selected adapter, one of the at least one selected adapter from receiving the external alternating current power source.

13. The multi-power management method according to claim 8, wherein the electronic device further comprises a battery module, and the required power value comprises a power value required for charging the battery module.

14. The multi-power management method according to claim 13, further comprising:
determining whether the battery module reaches a charge saturation state; and
when the battery module reaches the charge saturation state, stopping the adapters from receiving the external alternating current power source.
